(19) United States
(12) Patent Application Publication
(10) Pub. No.: US 2024/0070051 A1
(43) Pub. Date: Feb. 29, 2024

(54) SYSTEM AND METHOD OF ANALYZING SOFTWARE APPLICATION PERFORMANCE

(71) Applicant: Product Science Inc, Los Angeles, CA (US)

(72) Inventor: David Liberman, Los Angeles, CA (US)

(21) Appl. No.: 18/453,548

(22) Filed: Aug. 22, 2023

Related U.S. Application Data
(60) Provisional application No. 63/373,353, filed on Aug. 24, 2022.

(51) Int. Cl. G06F 11/36

(52) U.S. Cl. CPC G06F 11/3672

(57) ABSTRACT

A method and system for evaluating performance of software. The method and system includes inserting into the code trace markers where a given function has begun and ended. Inserting additional trace markers where a function is being called and scheduled to be executed later in the same or different threads. Saving the code including the trace markers in the computer database. Running and executing the code with the trace markers to draw paths on the trace recording creating a mapping of the full execution path of each function including its parent functions and all functions that are linked to the parent functions. Reviewing the mapping to determine which functions can be improved.

### CROSS-REFERENCE TO RELATED APPLICATIONS

Priority is claimed on Provisional Patent Application No. 63/373,353, filed Aug. 4, 2022, the contents of which are incorporated herein by reference in its entirety.

### TECHNICAL FIELD

This disclosure relates generally to the technical field of software performance evaluation and, more specifically, to a method and system for evaluating performance of a software application by using trace markers inserted into the code that identify when functions are executed to create a visual mapping of the execution path in order to identify areas where performance can be improved.

### BACKGROUND OF THE DISCLOSURE

Code tracing is a method to visualize the execution of a program or code segment to aid software engineers in the analysis of the performance of their application by capturing and displaying the execution times of their applications' processes. In the past, sifting through all the possible scenarios to optimize an application was extremely time-consuming and was often hit-or-miss to determine the source of the performance issues. Early on code tracing was primarily textual, until visual representations of the trace in cool colors (icicle) or warm colors (fire) charts became popular. In either icicle or fire charts, a “slice” represents the time between the beginning and the end of the execution of a code segment. The trace helps software engineers to analyze the code segments from historical data compiled from use of the application.

Software applications may execute several operations at the same time using multiple threads. Code can produce multiple results simultaneously, in parallel, and in different threads. Multi-threaded applications may include a large number of execution paths and may perform operations in an unexpected manner that affects performance.

For independent threads that are run in parallel, the beginning and the end of the thread can be seen during tracing. However, a function may be run in multiple threads, which requires asynchronous traces, resulting in a chart with more complexity for visualization. If multiple asynchronous threads are present, they can be grouped as being related to a single process. This is distributed tracing, which is a method used to track requests or transmissions throughout a transaction. While distributed tracing allows for top-down visibility of the infrastructure stack, it fails to show the real path of how the functions execute relative to each other. Although useful, distributed tracing does not show the direct connection in terms of how one function schedules another function, only that they are related to one transaction. This type of tracing simply tells you what is happening regarding the transaction that occurred, but not why it is happening, because the inter-relationship of the functions is not shown. Thus, the more complex the software the harder it is to sift through the various threads.

Determining the “why” of what is occurring during operation of the software application is challenging for software engineers because once “what” is happening is known there are a multitude of reasons “why” it might be happening. Conventional tracing shows only the record of the execution program with the sequence of operation but lacks the information about the link between the function and the place (in which function and at which time) it was scheduled. This inhibits software engineers from fully analyzing the cause of performance-related issues of their applications.

### SUMMARY OF THE DISCLOSURE

The present disclosure is directed to a method and system for evaluating performance of a software application by visually mapping the execution path of functions during use of the application to identify areas for improved performance. The system and method disclosed herein can be utilized with any of a variety of computer programs by inserting trace markers into the code at various points in the code, for example when a given function begins and where the function ends, or where a code segment may be executed in a parallel thread, to map the functions when they are executed by the program.

In an exemplary embodiment, trace markers can be added to a function or a code snippet to indicate that a given section of code has begun and ended. If within the trace markers the code defines a lambda function, then a trace marker can be added within the lambda function with an identifier which represents the initial trace marker.

In an exemplary embodiment, if a Runnable (or a Callable) is created from a function and added to a thread queue, a trace marker with an identifier of the Runnable (or Callable) can be added to the place in the code where it was added to the queue (e.g. where execution of the function “post” of the standard Handler class of Android SDK). Alternatively, if a Message was added to the thread queue, a trace marker with an identifier of the Message to the function responsible to handle the message may be added.

In an exemplary embodiment, a set of pairs of method name identifiers can be defined to link the closest slices on the timeline in the trace, which represent methods in a pair. In addition, a class instance identifier may be added to trace markers to link the closest slices which represent methods in a pair, and which also have the same instance identifier.

To add trace markers as described herein, the computer network that access the code may include an automated system, for example artificial intelligence, that can be utilized to analyze the code and add corresponding lines to the code including trace markers. Alternately, the system to analyze the code and insert trace markers may utilize methods such as bytecode injections or methods swizzling, as would be known to those of skill in the art. Alternatively, other methods of marking the code can be utilized in accordance with the present disclosure to achieve dynamic mapping and visualization, as would also be known to those of skill in the art.

In an exemplary embodiment, which function calls which threads are identified and may be drawn as the user is interacting with the application. Because the disclosed mapping utilizes dynamic tracing it does not require compiling data from multiple uses of the application for analysis, but only a single interaction, and provides an easily identifiable cause for performance-related issues. As will be appreciated, the presently disclosed method and/or system allows for visualization of all the links of its parent functions, and recursively the links of all functions that are linked to the parent functions, to visualize the full execution path which led to the execution of a particular function of the application. As used herein, parent functions include not only those functions which execute the runnable, but also the function which scheduled the runnable.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of exemplary embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 is a graphical representation of a prior art distributed trace;

FIG. 2 is an illustration of lines of code without trace markers and the lines of code with trace markers inserted according to the present disclosure;

FIG. 3 is a diagram of the system of the present disclosure;

FIG. 4 is a flowchart of a method of trace marking according to the present disclosure;

FIG. 5 is a flowchart of a method of executing the trace marking;

FIG. 6 is a diagram of optional steps according to the system of the present disclosure;

FIG. 7A is a graphical representation of a trace run without the trace markers;

FIG. 7B is a graphical representation of a trace run with the trace markers inserted to create paths for mapping according to the present disclosure;

FIG. 8A is a graphical representation of a trace run without the trace marking;

FIG. 8B is a graphical representation of a trace with the trace markers inserted to create paths for mapping according to the present disclosure; and

FIG. 8C is a graphical representation of a trace with the trace markers inserted to create paths with different colors for different paths according to the present disclosure.

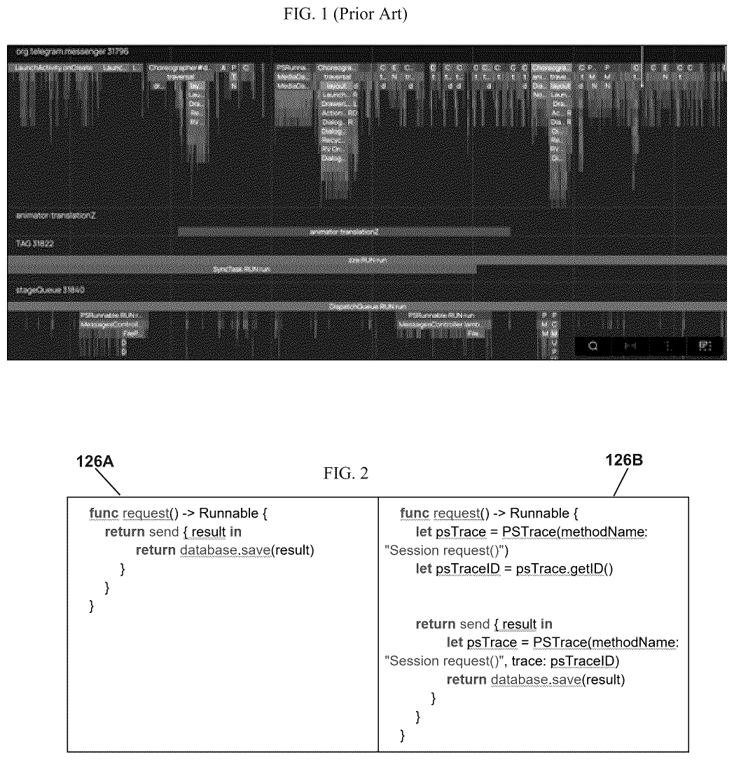

### DETAILED DESCRIPTION OF THE DISCLOSURE

This disclosure includes examples and references to specific characteristics of marking code to create one or more paths, which together make a visual map, to improve the ease of identification of areas of code where performance can be improved, i.e., optimized. The paths are represented in yellow in the exemplary embodiment but may be represented in any color. The examples and references are provided as exemplary embodiments for the purposes of disclosure and are not intended to limit the scope of the system and methods disclosed herein.

Various embodiments are described below with reference to block diagrams and flowchart illustrations of methods, apparatuses (e.g., systems) and computer program products. Each block of the block diagrams and flowchart illustrations, and combinations of blocks in the block diagrams and flowchart illustrations, respectively, can be implemented by a computer executing computer program instructions. These computer program instructions may be loaded onto a general-purpose computer, special purpose computer, or other programmable data processing apparatus, such that the instructions execute on the computer or other programmable data processing apparatus to implement the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, are not limited to the order in which they are presented.

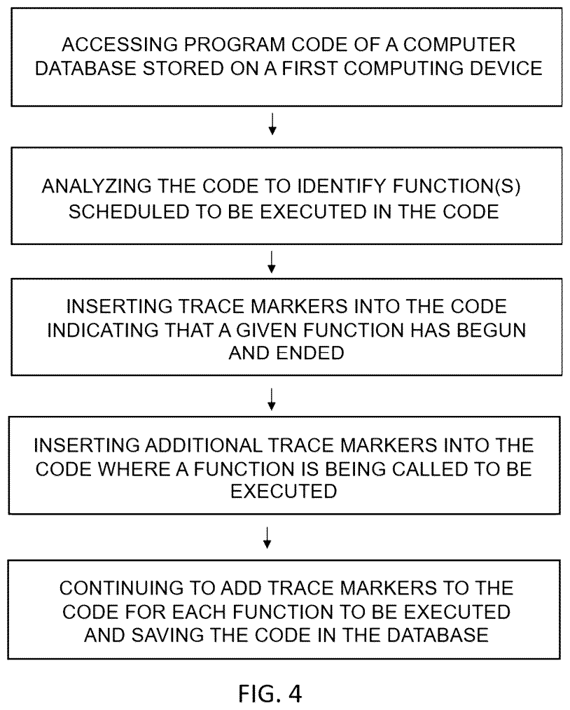

Referring now to FIG. 3, in various embodiments system 100 includes one or more computer databases 110, which store the computer program code on a first computing device 111 that may include a user interface 112. The user interface 112 may include, for example, a monitor or screen and an input device such as a mouse, keyboard, or touch screen that allows the user 109 to interact with the program. One or more second computing devices 114 can be used to access the program code to insert the trace markers disclosed herein, to view the mapping created by the trace markers, and may also include a user interface 113. The computer databases 110 may be accessed by the computing devices 114 through a direct connection or a transmission medium such as a local-area network or a wide-area network, such as the Internet.

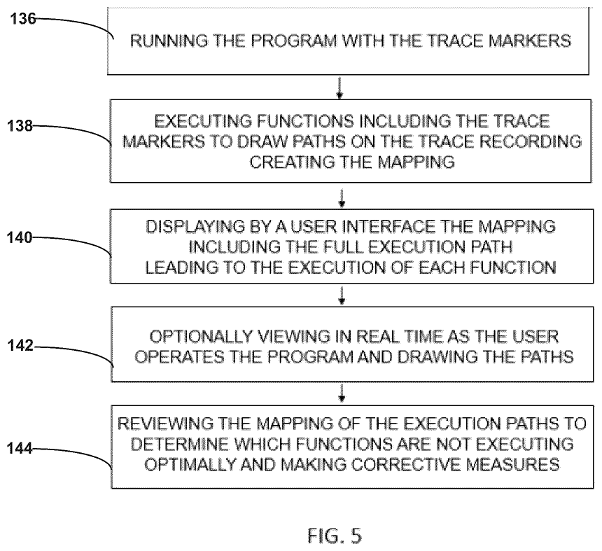

Referring now to FIG. 4, in the exemplary embodiment in a first step 116 the program code is accessed by the one or more second computing devices 114, and in a second step 118 a plurality of lines of code are analyzed to identify the various functions and code segments that are scheduled to be executed. Alternatively, the program code can be accessed by the same computer which stores the code. Once identified, in a third step 120 trace markers are inserted into the code indicating that a given function has begun and ended. Additional trace markers may also be inserted into the code where a function is being called to be executed 122. Additional functions, for example, a lambda function, a closure function, or a code snippet can also be added, for example by marking the beginning and end of a function and/or to identify where functions are scheduled to be executed later in the same thread or in another thread 124, as described in more detail herein.

The computer network that accesses the code can include an automated system, for example artificial intelligence, that can be utilized to analyze the code and add corresponding lines to the code including trace markers. Alternatively, the system to analyze the code and insert trace markers may utilize methods such as bytecode injections or methods swizzling, i.e., adding custom code before the original code, as would be known to those of skill in the art. Other methods of marking the code can be utilized in accordance with the present disclosure to achieve dynamic mapping and visualization.

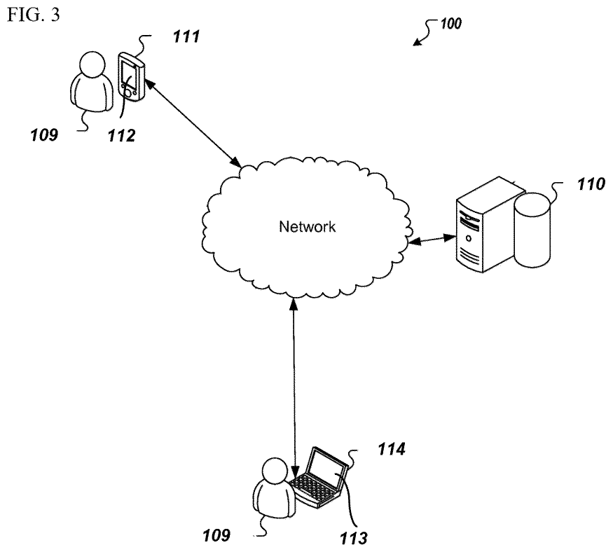

As illustrated in FIG. 2, exemplary lines of code in left-hand column 126A do not include trace markers, and in the right-hand column 126B trace markers have been inserted. If within the trace markers identifying the beginning and end of the function the code defines a lambda function, then a trace marker can also be added within the lambda function with an identifier that represents the initial trace marker.

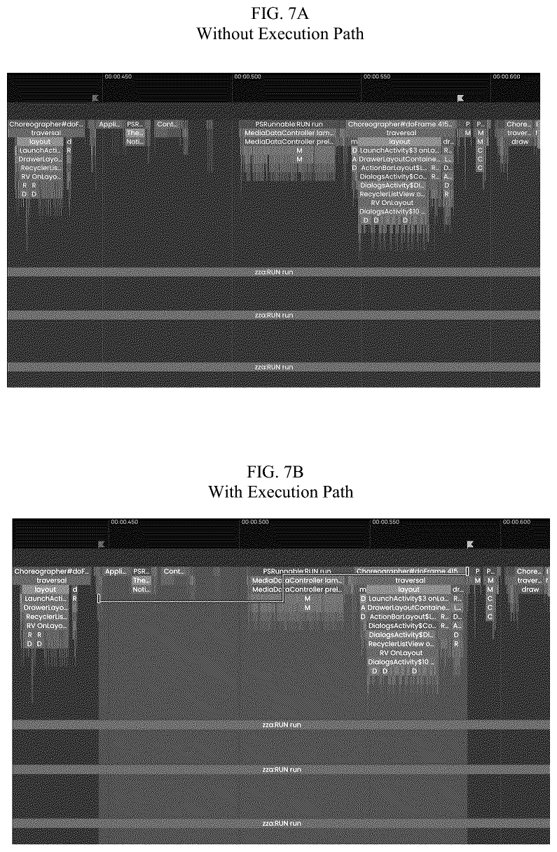

In an exemplary embodiment of FIG. 6 optional additional steps are illustrated. Some, all or none of these optional additional steps may be included and may take place in any order. For example, if a Runnable or a Callable is created from a function and added to a thread queue in the code, a trace marker with an identifier of the Runnable or Callable can be placed in the code where the Runnable or Callable was added to the queue 128 (e.g., execution of the function “post” of the standard Handler class of Android SDK). Additionally, if a Message was added to the thread queue, a trace marker with an identifier of the Message to the function responsible for handling the message may be added 130. Pairs of method name identifiers can be defined and added to the trace markers to link the closest slices on the timeline in the trace which represent methods in a pair 132. In addition, a class instance identifier may be added to trace markers to link the closest slices which represent methods in a pair, and which also have the same instance identifier 134.

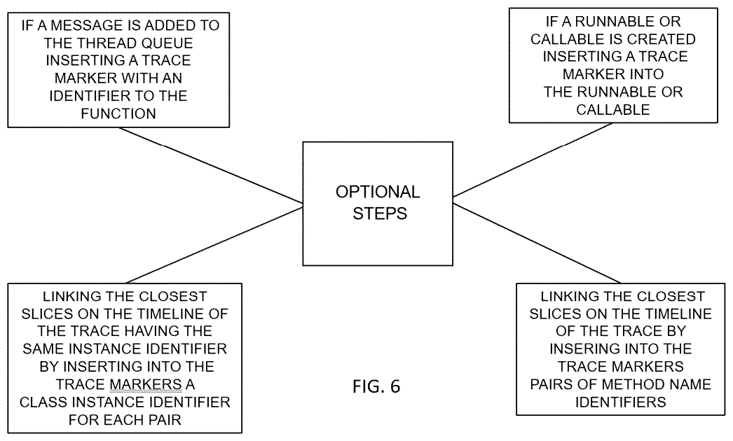

Referring now to FIG. 5, once the trace markers are inserted into the code, the application stored on the computer database 110 can be run 136. As the program is run, the trace markers and their corresponding functions are executed to create a trace recording 138 for review by the software engineers. As the trace is reviewed, paths can be drawn on the trace recording at any point that the software engineer desires to visualize the full execution path, for example, on the second computing device. In another exemplary embodiment, an automated system, for example artificial intelligence, can be used to determine where the code may need optimization and can autonomously draw paths on the trace recording to map the full execution path corresponding to each function identified as a potential target for improved functionality. Alternatively, only a single computing device may be utilized to run the application and produce the trace recording. Once mapped, the code can be easily reviewed to determine which functions are not executing optimally so that corrective measures may be taken.

In one exemplary embodiment, the creation of the trace and drawing of the paths may be done concurrently as the user operates the program and recorded during operation 142 while the mobile application is being run. For example, if when a user selects a button on the screen to move to a next step the application slows down, the present mapping technique is able to draw the sequence that the application is running to execute the function as the button is selected. The mapping of the paths is then reviewed to determine which functions are not operating optimally 144, e.g., when the button is pressed by the user, to determine why the application is slowing down in order to correct the problem thereby improving performance of the application.

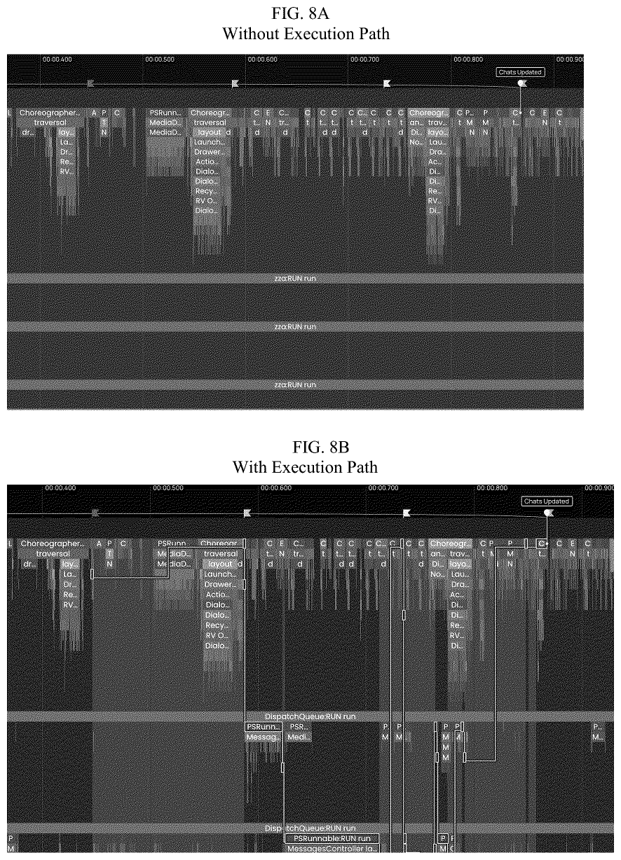

The placement and execution of the trace markers as disclosed herein results in a path being drawn when the code is run, the combination of paths forming a mapping, as discussed hereinabove. As a result, the link between a particular function and the function it was scheduled from can be readily seen, e.g., by adding a line that represents this connection, as well as any other functions in the thread, and understood by following the path that has been drawn. Compared to running the same code without the trace markers being placed in the code, as shown in FIG. 7A, the visualization provided by the paths can be readily appreciated in FIG. 7B.

In the exemplary embodiment, the paths are drawn to show visualization of all the links of a function, its parent functions, and recursively the links of all functions that are linked to the parent functions, to visualize the full execution path which led to the execution of a particular function of the application. For example, if a function schedules a task to perform a network request in a dedicated thread and then to perform a closure function when the corresponding response will be received, a path from the closure function to the function which performed the network request and to the initial function where the network request was scheduled is drawn to visualize the full execution path.

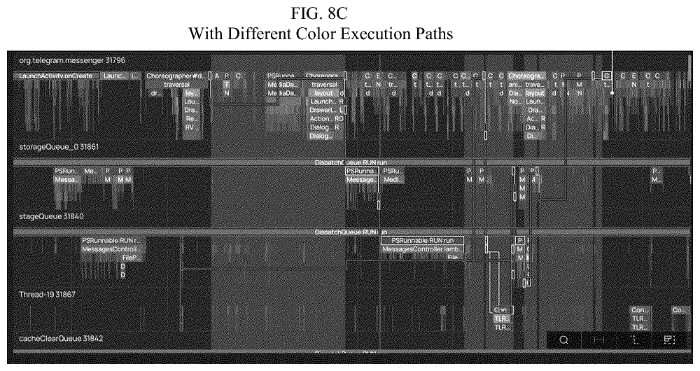

The mapping created according to the present disclosure aids in understanding complicated scenarios, for example where a function is run in multiple threads leading to asynchronous traces. The resulting traces have more complexity for visualization when drawn without trace marking, an example of which is shown in FIG. 8A. However, the addition of paths to map all functions that are linked, regardless of whether they are run in multiple threads, allows for a greater understanding without complicated analysis, as shown in the path that is mapped as a yellow line in the example illustrated in FIG. 8B, where multiple threads are involved. In addition to the foregoing, multiple paths can also be drawn, utilizing the same or different colored lines to aid in the visualization, for examples as shown in FIG. 8C.

Conventional traces lack the information about the link between the function and the place (in which function and at which time) it was scheduled. The present disclosure improves optimization for computer programs by providing dynamic mapping and visualization that links the function to the place and the time the function was scheduled. Through dynamic tracing the system and method disclosed herein allows for real-time evaluation without the need for collecting historical data that enhances the evaluation of software programs by readily and easily identify areas where performance can be improved. The enhanced visualization of the paths show not only where optimization may be needed, but why it is happening because the inter-relationship of the functions is mapped, along with when and where the functions were scheduled and executed.

It will be appreciated from the above that the invention may be implemented by marking software applications, which may take the form of a mobile application or as an application on a computer, through a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is implemented. Given the teachings of the present disclosure provided herein, one of ordinary skill in the related art will be able to contemplate these and similar implementations or configurations of the present disclosure.

While the principles of the invention have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure. In addition, it is to be understood that the phraseology and terminology used herein is for the purpose of description and should not be regarded as limiting. The use of “including,” “comprising,” “containing,” “involving,” or “having,” and variations thereof herein, is meant to encompass the items listed thereafter and equivalents thereof as well as additional items while only the terms “consisting only of” or “consisting essentially of” are to be construed in a limitative sense. References to “or” may be construed as inclusive so that any terms described using “or” may indicate any of a single, more than one, and all of the described terms.

1. A method for evaluating performance of a software application comprising:
accessing the program code of a computer database on a first computing device;
analyzing the program code to determine where functions are scheduled to be executed;
inserting into the program code a first trace marker indicating where a given function has begun and a second trace marker indicating where the given function has ended, the first and second trace markers defining a pair;
continuing to insert into the program code a plurality of pairs of first trace markers and second trace markers at the beginning and ending of each function within the code;
running the program code including the trace markers on one of the first computing device or a second computing device and recording the trace; and
wherein an execution path is drawn on the trace recording for each function that is executed, creating a visual mapping of all executed functions.

2. The method of claim 1, further comprising the steps of inserting additional trace markers where a function is being called and where a function is being scheduled to be executed later in the same thread or different threads.

3. The method of claim 1, further comprising the step of adding a third trace marker with an identifier within a lambda function if the code defines the lambda function within one of the pairs of trace markers.

4. The method of claim 1, wherein upon a Runnable or Callable being created from a function and added to a thread queue, a trace marker with an identifier of the Runnable or Callable is added to the place in the code where the Runnable or Callable was added to the thread queue.

5. The method of claim 1, wherein upon a Message being added to the thread queue, a trace marker with an identifier of the Message is added to the function responsible to process the Message.

6. The method of claim 1, further comprising the step of defining pairs of method name identifiers and adding the pairs of method name identifiers to the trace markers to link the closest slices on the timeline in the trace.

7. The method of claim 7, further comprising the step of adding a class instance identifier to the trace markers to link the closest slices that represent methods in a pair and that also have the same class instance identifier.

8. The method of claim 1, wherein the one or more second computing devices includes an automated system to analyze the code and add corresponding lines to the code including trace markers.

9. The method of claim 1, wherein the portion of the trace to optimize is determined autonomously and the execution path is drawn automatically.

10. The method of claim 9, wherein the execution path of each function includes its parent functions and all the functions that are linked to the parent functions.

11. The method of claim 1, wherein to analyze the code and insert the trace markers swizzling is utilized.

12. The method of claim 1, wherein to analyze the code and insert the trace markers bytecode injections are utilized.

13. The method of claim 1, further comprising the step of reviewing the trace recording to identify areas where performance can be improved

14. A system for evaluating performance of a software application comprising:
a program code stored on a computer database of a first computing device, the program code including a plurality of first trace markers indicating where a given function has begun and a plurality of corresponding second trace markers indicating where the given function has ended;
the program code including the plurality of first and second trace markers producing a trace recording including one or more execution paths for each function that has been executed, the one or more execution paths connecting inter-related functions, and illustrating when and where each of the functions are scheduled and executed.

15. The system of claim 14, wherein the program code further comprises one or more third trace markers with an identifier within a lambda function when the lambda function is within the first and second trace markers.

16. The system of claim 14, wherein the program code further comprises one or more fourth trace markers with an identifier of a Runnable or Callable where the Runnable or Callable was added to a thread queue.

17. The system of claim 14, wherein the program code further comprises one or more fifth trace markers with an identifier of a Message at a function responsible to process the Message.

18. The system of claim 14, wherein the first and second trace markers each include method name identifiers, the method name identifiers linking the closest slices on the timeline in the trace recording.

19. The system of claim 14, wherein the first and second trace markers each include a class instance identifier, the class instance identifiers link the closest slices that represent methods in a pair that also have the same class instance identifier.

20. The system of claim 14, wherein the one or more execution paths of each function includes execution paths for one or more parent functions and all functions that are linked to the parent functions.
